(19) United States
(12) Patent Application Publication
(10) Pub. No.: US 2021/0066715 A1
(43) Pub. Date: Mar. 4, 2021

(54) CATHODE ACTIVE MATERIAL FOR NON-AQUEOUS ELECTROLYTE SECONDARY BATTERY, METHOD OF MANUFACTURING CATHODE ACTIVE MATERIAL FOR NON-AQUEOUS ELECTROLYTE SECONDARY BATTERY, AND METHOD OF EVALUATING LITHIUM METAL COMPOSITION OXIDE POWDER

(71) Applicant: SUMITOMO METAL MINiNG CO., LTC., Tokyo (JP)

(72) Inventors: Tomoko NAKAYAMA, Ehime (JP); Takahiro TOMA, Ehime (JP); Takahiro OGAWA, Ehime (JP); Kazuomi RYOSHI, Ehime (JP)

(21) Appl. No.: 16/757,858

(22) PCT Filed: Aug. 31, 2018
(86) PCT No.: PCT/JP2018/032472

§ 371 Date: Apr. 21, 2020

(30) Foreign Application Priority Data
Oct. 30, 2017 (JP) 2017-209846
Mar. 14, 2018 (JP) 2018-046465

(51) Int. Cl. H01M 4/525; H01M 4/485; H01M 4/1391; H01M 10/0525; H01M 4/04

(52) U.S. Cl. CPC H01M 4/525; H01M 4/485; H01M 4/1391; H01M 2300/002; H01M 4/0471; H01M 2300/0034; H01M 10/0525

(57) ABSTRACT

A cathode active material for a non-aqueous electrolyte secondary battery containing a lithium metal composition oxide powder, wherein the lithium metal composition oxide powder is represented by a general formula: Li_{z}Ni_{1-x-y-t}CoₓAl_{y}MₜO_{2+α} (where 0<x≤0.15, 0<y≤0.07, 0≤t≤0.1, x+y+t≤0.16, 0.95≤z≤1.03, 0≤α≤0.15), and M is one or more elements selected from Mg, Ca, Ti, V, Cr, Zr, Nb, Mo, Hf, Ta, W), and wherein Al/(Ni+Co), which is a mass ratio of Al relative to Ni+Co in the lithium metal composition oxide powder after the lithium metal composition oxide powder of 1 kg is water washed of 750 mL, is 90% or higher of that of the lithium metal composition oxide powder before water washing.

### TECHNICAL FIELD

The present invention relates to a cathode active material for a non-aqueous electrolyte secondary battery, a method of manufacturing a cathode active material for a non-aqueous electrolyte secondary battery, and a method of evaluating a lithium metal composition oxide powder.

### BACKGROUND ART

In recent years, with popularization of portable information terminals such as mobile phones and notebook personal computers, there has been a demand for the development of small and lightweight non-electrolyte secondary battery with high energy density. It is also required to develop high-output secondary batteries as batteries for electric vehicles such as hybrid vehicles.

A non-aqueous electrolyte secondary battery that meets these requirements is a lithium-ion secondary battery. The lithium-ion secondary battery is formed of, for example, a cathode, an anode, and electrolyte solution, active material of the cathode and the anode enabled to de-insert and inserting lithium.

Research and development of lithium-ion secondary batteries actively undergo, but lithium-ion secondary batteries using layered or spinel-type lithium-metal-oxide composite as a cathode active material obtain high voltages of the 4V class, and hence they are being commercialized as batteries with high energy density.

Examples of the cathode active material that have been mainly proposed include lithium cobalt composition oxide (LiCoO₂), which are relatively easy to synthesize, lithium nickel composition oxides (LiNiO₂), which use nickel less expensive than cobalt, lithium nickel cobalt manganese composition oxides (LiNi_{1/3}Co_{1/3}Mn_{1/3}O₂), and lithium manganese composition oxides (LiMn₂O₄), which use manganese.

Of these, lithium nickel composition oxides have attracted attention as a material providing a high battery capacity. Furthermore, in recent years, it is important that a lower resistance is required for a higher output. As a method of realizing the above lower resistance, an addition of a different element is used, and a transition metal having a high valence number such as W, Mo, Nb, Ta, Re, etc. is particularly useful.

For example, Patent Document 1 proposes a cathode active material for a lithium secondary battery featured to have a layered structure and is made of a lithium-containing composition oxide represented by the formula of LixNiaCobMcO2 (0.8≤x≤1.2, 0.01≤a≤0.99, 0.01≤b≤0.99, 0.01≤c≤0.3, 0.8≤a+b+c≤1.2, and M is at least one element selected from Al, V, Mn, Fe, Cu, and Zn).

### CITATION LIST

### Patent Literature

### [PTL 1]

### Japanese Unexamined Patent Application No. 08-213015

### SUMMARY OF INVENTION

### Technical Problem

However, in recent years, there has been a need for further improvement in the performance of non-aqueous electrolyte secondary batteries. For this reason, there is a need for a material that may improve the performance of the cathode active material for the non-aqueous electrolyte secondary battery when it is used for a non-aqueous electrolyte secondary battery. Specifically, in the case of a non-aqueous electrolyte secondary battery, there is a need for a cathode active material for a non-aqueous electrolyte secondary battery that has a high initial discharge capacity and may suppress the cathode resistance.

Accordingly, in view of the problems of the above background art, it is an object of the present invention to provide a cathode active material for a non-aqueous electrolyte secondary battery having a high initial discharge capacity and capable of suppressing a cathode resistance when it is used as a non-aqueous electrolyte secondary battery.

### Solution to Problem

In order to solve the above problem, according to one aspect of the invention, it is a cathode active material for a non-aqueous electrolyte secondary battery containing a lithium metal composition oxide powder, wherein the lithium metal composition oxide powder is represented by a general formula: Li_{z}Ni_{1-x-y-t}CoₓAl_{y}MₜO_{2+α} (where 0<x≤0.15, 0<y≤0.07, 0≤t≤0.1, x+y+t≤0.16, 0.95≤z≤1.03, 0≤α≤0.15), and M is one or more elements selected from Mg, Ca, Ti, V, Cr, Zr, Nb, Mo, Hf, Ta, W), and wherein Al/(Ni+Co), which is a mass ratio of Al relative to Ni+Co in the lithium metal composition oxide powder after the lithium metal composition oxide powder of 1 kg is water washed of 750 mL, is 90% or higher of that of the lithium metal composition oxide powder before water washing.

### Advantageous Effects of the Invention

According to an aspect of the present invention, when the non-aqueous electrolyte secondary battery is used, it is possible to provide the cathode active material for the non-aqueous electrolyte secondary battery that has a high initial discharge capacity and is capable of suppressing the cathode resistance.

### BRIEF DESCRIPTION OF DRAWINGS

FIG. 1 is an explanatory view of a cross-sectional structure of a coin battery fabricated in an example and a comparative example.

FIG. 2A is an example of measuring an impedance.

FIG. 2B is a schematic equivalent circuit used to analyze an impedance evaluation result.

### DESCRIPTION OF EMBODIMENTS

While embodiments of the invention will now be described with reference to the accompanying drawings, the invention is not limited to the following embodiments, and various modifications and substitutions may be made to the following embodiments without departing from the scope of the invention.

### (1) Cathode Active Material for Non-Aqueous Electrolyte Rechargeable Battery

Hereinafter, an example of a cathode active material for a non-aqueous electrolyte secondary battery according to this embodiment will be described.

The cathode active material for the non-aqueous electrolyte secondary battery according to this embodiment (hereinafter, also referred to as “cathode active material”) includes a lithium metal composition oxide powder. The lithium metal composition oxide powder is then represented by a general formula: Li_{z}Ni_{1-x-y-t}CoₓAl_{y}MₜO_{2+α}. Incidentally, it is preferable that x, y, t, and z in the above general formula satisfy 0<x≤0.15, 0<y≤0.07, 0≤t≤0.1, x+y+t≤0.16, 0.95≤z≤1.03, 0≤α≤0.15. Then, M may be one or more elements selected from Mg, Ca, Ti, V, Cr, Zr, Nb, Mo, Hf, Ta, and W. In addition, when the lithium metal composition oxide powder is washed with water of 750 mL, a mass ratio Al/(Ni+Co) of the lithium metal composition oxide powder after water washing is 90% or more of Al/(Ni+Co) of the lithium metal composition oxide powder before water washing.

Hereinafter, the mass ratio of Al/(Ni+Co), which is the mass ratio of Al contained in the lithium metal composition oxide powder after water washing to Ni and Co, to Al/(Ni+Co) of the lithium metal composition oxide powder before washing is represented as Al maintenance ratio.

The inventor of the present invention thoroughly studied the positive electrode active material which has a high initial discharge capacity and can suppress the cathode resistance when it is used as a non-aqueous electrolyte secondary battery. The inventor of the present invention thoroughly studied the cathode active material which has a high initial discharge capacity and may suppress the cathode resistance when it is used as a non-aqueous electrolyte secondary battery.

The cathode active material of this embodiment includes a lithium metal composition oxide powder as described above. The cathode active material according to this embodiment may be made from only lithium metal composition oxide powder. Even in this case, however, this does not exclude the inclusion of unavoidable ingredients mixed in a manufacturing process or the like.

The lithium metal composition oxide powder is represented by a general formula: Li_{z}Ni_{1-x-y-t}CoₓAl_{y}MₜO_{2+α} (where 0<x≤0.15, 0<y≤0.07, 0≤t≤0.1, x+y+t≤0.16, 0.955≤z≤1.03, 0≤α≤0.15). In the above general formula, Li represents lithium, Ni represents nickel, Co represents cobalt, Al represents aluminum, and O represents oxygen. Hereinafter, these elements may be expressed simply by the symbol of the element. Further, M is an additional element, and M may be one or more elements selected from Mg, Ca, Ti, V, Cr, Zr, Nb, Mo, Hf, Ta, and W. When the additional element M is further added to the non-aqueous electrolyte secondary battery using the cathode active material including the lithium metal composition oxide powder, the battery property such as the cycle characteristics and the output characteristics can be further improved.

Incidentally, when the additional element M is not added, the lithium metal composition oxide powder is represented by the general formula: Li_{z}Ni_{1-x-y}CoₓAl_{y}O_{2+α} (where 0<x≤0.15, 0<y≤0.07, x+y≤0.16, 0.95≤z≤1.03, 0≤α≤0.15).

In the above general formula, Co, Al, and M are substituted with a part of Ni, but it is preferable that x+y+t, which represents the substitution ratio of Ni to other elements, be 0.16 or smaller as described above. This is because the substitution rate of nickel with other elements is set to 16% or lower and thus the ratio of lithium nickelate may be increased and the charge/discharge capacity of the cathode active material may be increased, thereby increasing the stability.

By using a cathode active material containing such a lithium metal composition oxide powder, a high charge/discharge capacity may be obtained.

As described above, by using a cathode active material including lithium metal composition oxide powder having a ratio of de-inserting Al when a water wash for evaluating an Al maintenance ratio is performed, the initial discharge capacity is high and the cathode resistance may be suppressed when a non-aqueous electrolyte secondary battery is used.

The cathode active material of this embodiment contains a lithium metal composition oxide powder expressed by the above general formula containing Li and Al. The cathode active material according to this embodiment may be manufactured by firing a raw material mixture of, for example, a nickel composition oxide containing Al and a lithium compound as described below.

The lithium metal composition oxide powder is considered to be formed by dispersing lithium from the lithium compound into the particles of the nickel composition oxide by firing the raw material mixture.

However, according to the inventors of the present invention, when firing the raw material mixture, it is considered that a part of Al contained in the particles of the nickel composition oxide is de-inserted on the surface of the particles of the nickel composition oxide, and Li and LiAlO₂, which are Li—Al compounds, may be formed. As described above, when a part of Al contained in the particles of the nickel composition oxide is de-inserted, the particles of the lithium metal composition oxide obtained after firing also include a portion having a high resistance (a high resistance portion) in which Al was de-inserted, and the cathode resistance is also increased even with the cathode active material including the particle of the lithium metal composition oxide before washing.

In addition, because LiAlO₂ is soluble in water, when LiAlO₂ is adhered to the surface of particles of lithium metal composition oxide powder, LiAlO₂ is eluted when the lithium metal composition oxide powder is water washed for evaluating the Al maintenance ratio. Therefore, as described above, when a part of Al contained in the particles of the nickel composition oxide as the raw material is de-inserted and LiAlO₂ is generated, the Al maintenance ratio of the lithium metal composition oxide powder obtained from the nickel composition oxide after water washing for evaluating the Al maintenance ratio is reduced.

In addition, when the lithium metal composition oxide powder having LiAlO₂ deposited on the particle surface is water washed for evaluating the Al maintenance ratio, an excess Li compound on the particle surface of the lithium metal composition oxide powder is removed in addition to the LiAlO₂. Furthermore, because Al is de-inserted, Li near the surface of the particle of the lithium metal composition oxide powder easily escapes from the crystal, and Li escapes, so that a layer having a high resistance (a high resistance layer) is easily formed on the particle of the lithium metal composition oxide powder. Therefore, the resistance further increases by a synergistic effect with the high resistance layer due to the de-insertion of Al.

For the reasons described above, it is considered that the cathode resistance increases and the initial discharge capacity decreases for the cathode active material containing the lithium metal composition oxide powder which has a low Al maintenance ratio after water washing for evaluating the Al maintenance ratio when the cathode active material is used for a non-aqueous electrolyte secondary battery.

Therefore, in the lithium metal composition oxide contained in the cathode active material according to this embodiment, the ratio of de-inserting Al in the water washing for evaluating the Al maintenance ratio is low. the differently, the Al maintenance ratio after water washing for evaluating the Al maintenance ratio in comparison with the Al maintenance ratio before water washing for evaluating the Al maintenance ratio is high. Therefore, when the cathode active material according to this embodiment is applied to the non-aqueous electrolyte secondary battery, it is possible to suppress the cathode resistance and increase the initial discharge capacity.

It is preferable that the lithium metal composition oxide contained in the cathode active material according to the present embodiment has an Al maintenance ratio of 90% or higher before and after water washing for evaluating the Al maintenance ratio. In addition, the upper limit of the Al maintenance ratio is not particularly limited, for example, 100% or lower.

Incidentally, in the step of manufacturing the cathode active material according to the present embodiment, when the lithium metal composition oxide powder is not water washed, at least a trace amount of Al is eluted by water washing for evaluating the Al maintenance ratio. Therefore, when the lithium metal composition oxide powder is not water washed in the manufacturing process of the cathode active material, the Al maintenance ratio of the lithium metal composition oxide powder before and after the water washing for Al maintenance ratio is, for example, 90% or higher and 98% or lower.

According to the inventor of the present invention, when lithium metal composition oxide powder is water washed for evaluating the Al maintenance ratio, Ni and Co are scarcely eluted. Therefore, it is possible to evaluate a comparison between the Al maintenance ratio before water washing for evaluating the Al maintenance ratio and the Al maintenance ratio after water washing for evaluating the Al maintenance ratio by, for example, a change rate of the mass ratio between Al contained in the lithium metal composition oxide powder to (Ni+Co) before and after water washing.

The mass ratio of Al in the lithium metal composition oxide powder to (Ni+Co) may be calculated from the abundance of each metal in the lithium metal composition oxide powder, as measured by, for example, an ICP (inductively coupled plasma) emission spectrometer.

In addition, the conditions of the water washing for evaluating the Al maintenance ratio are not particularly limited, for example, the water washing may be performed with water of 750 mL for a lithium metal composition oxide powder of 1 kg.

The specific procedure for washing the water for evaluating the Al maintenance ratio is not particularly limited. The water washing for evaluating the Al maintenance may be performed by, for example, adding water to the lithium metal composition oxide powder, slurrying, stirring, providing filtration, and drying.

As described above, when washing water for evaluating the Al maintenance ratio, water is first added to the lithium metal composition oxide powder to form a slurry.

Particularly, it is preferable that the water used for the water washing for evaluating the Al maintenance ratio be of a low electrical conductivity, for example, water having an electrical conductivity of less than 10 μS/cm, and more preferably water having an electrical conductivity of 1 μS/cm or lower.

In addition, it is preferable to select the temperature of water so that the temperature of the slurry is 10° C. or higher and 40° C. or lower.

Although the water washing time of the water washing for evaluating the Al maintenance ratio is not particularly limited, it is preferable that the water washing time be 10 minutes or longer and 2 hours or shorter, for example, from the viewpoint of sufficiently removing LiAlO₂ adhered to the surface of particles of the lithium metal composition oxide powder also in a viewpoint of increasing productivity. It is preferable that the prepared slurry be stirred during the water washing for evaluating the Al maintenance ratio.

Next, the filtration may be performed. A means for the filtration is not particularly limited, but for example, a filter press or suction filtration using a Buchner funnel may be used.

A filtrate may then be dried. Drying conditions when the filtrate is dried after filtration are not particularly limited, but it is preferable that the drying conditions are 80° C. or higher and 700° C. or lower, and more preferably, the drying conditions are 100° C. or higher and 550° C. or lower, and further preferably, the drying conditions are 120° C. or higher and 350° C. or lower.

The atmosphere of the drying process is not particularly limited, but is preferably carried out under, for example, a vacuum atmosphere.

As for the lithium metal composition oxide powder contained in the cathode active material according to the present embodiment, for example, the lithium metal composition oxide powder obtained after the firing process may be used without using water washing in the manufacturing process, as described later. However, it may be possible to use a composition oxide powder obtained after water washing in the manufacturing process. Here, the water washing is performed in the manufacturing process of the cathode active material and is different from the above water washing for evaluating the Al maintenance ratio.

When the water washing is performed in the manufacturing process, LiAlO₂ adhering to the surface of particles of lithium metal composition oxide powder is removed to a certain extent during the washing process. Therefore, even if the lithium metal composition oxide powder is further washed for evaluating the Al maintenance ratio, Al dissolution rarely occurs.

Accordingly, in the lithium metal composition oxide powder for which water washing is performed in the manufacturing process, when the water washing for evaluating the Al maintenance ratio is performed as described above, the Al maintenance ratio of the lithium metal compound powder may be greater than 98%. Specifically, for the lithium metal composition oxide powder that is water washed in the manufacturing process, and when the lithium metal composition oxide powder is washed with water of 750 mL for the lithium metal composition oxide powder of 1 kg, Al/(Ni+Co) that is the mass ratio of Al to Ni and Co of the lithium metal composition oxide powder after water washing may be higher than 98% of that of Al/(Ni+Co) of the lithium metal composition oxide powder before water washing.

Incidentally, for lithium metal composition oxide powder for which water washing in the manufacturing process, the upper limit of the Al maintenance ratio in the water washing for evaluating the Al maintenance ratio is not particularly limited, but may be, for example, 100% or lower.

When the water washing is performed in the manufacturing process as described above, it is preferable that the ratio of lithium disposed on the particle surface of the lithium metal composition oxide powder to the lithium metal composition oxide powder be 0.1% by mass or lower.

The lithium metal composition oxide powder may be synthesized by mixing a lithium compound with a nickel composite oxide and heating the resulting raw material mixture. As described above, it is considered that by heating and firing the raw material mixture, lithium diffuses into the nickel composition oxide and a lithium metal composition oxide is generated in the raw material mixture. However, if the mass ratio of lithium to the constituent elements other than lithium in the raw material mixture is too low, the synthesis reaction of the lithium metal composition oxide is difficult to progress, especially in the center of the particles. Thus, when preparing the raw material mixture, the ratio of lithium mass to non-lithium constituent elements in the raw material mixture may be greater than near the stoichiometric ratio of the desired composition. When preparing the raw material mixture, it is preferable that the ratio of the mass of lithium to the constituent elements other than lithium in the raw material mixture be the same as, for example, the stoichiometric ratio of the target composition.

However, when the mass ratio of lithium to the constituent elements other than lithium in the raw material mixture is mixed so that the ratio is greater than the stoichiometric ratio of the composition, the lithium compound remains on the particle surface of the lithium metal composition oxide powder, although the synthesis reaction of the lithium metal composition oxide proceeds completely. In addition, lithium hydroxide and lithium compounds such as lithium carbonate that do not form a lithium metal composition oxide but remain on the particle surface of the lithium metal composition oxide powder are also described as surface lithium.

Surface lithium does not contribute to the charge-discharge reaction and may also be a resistive layer during charge-discharge at the surface of lithium metal oxide particles. In addition, surface lithium may cause gas generation during charging and discharging of the non-aqueous electrolyte secondary battery, especially during charging and discharging at high temperatures.

Therefore, it is preferable that the lithium metal composition oxide powder containing the cathode active material according to the present embodiment is water washed in the manufacturing process and the amount of surface lithium is suppressed.

It is preferable that the ratio of lithium derived from surface lithium on the particle surface of the lithium metal composition oxide powder contained in the cathode active material according to the present embodiment to the lithium metal composition oxide powder (hereinafter, simply referred to as “lithium amount”) is 0.1% by mass or lower.

This is because the lithium amount on the surface of the particle surface of the lithium metal composition oxide powder is sufficiently suppressed by making the lithium amount 0.1% by mass or lower, so that the initial discharge capacity may be particularly increased and the cathode resistance may be particularly suppressed. In addition, the cathode active material containing the lithium metal composition oxide powder is applied to the secondary battery, and gas generation may be particularly suppressed even when the charge and discharge are performed at a high temperature.

Incidentally, in a secondary battery in which the cathode active material including the lithium metal composition oxide powder is applied, when the charge and discharge are performed at a high temperature, a gas is generated due to lithium hydroxide remaining on the particle surface of the lithium metal composition oxide powder or lithium carbonate. Lithium compounds other than lithium hydroxide and lithium carbonate may be present as surface lithium on the particle surfaces of lithium metal composition oxide powders, but when manufactured under normal conditions, the majority are lithium hydroxide and lithium carbonate. Therefore, because the lithium amount is set to 0.1% by mass or lower as described above, it is possible to suppress the generation of gas when charging and discharging is performed at high temperature.

It is more preferable that the amount of such lithium be not more than 0.05% by mass.

On the other hand, the lower limit of the amount of such lithium is not particularly limited, but preferably 0.01% by mass or higher. By setting the lithium amount to 0.01% by mass or higher, the lithium metal composition oxide powder may be washed excessively, and it is possible to prevent lithium near the surface of the particles from de-inserting the crystal structure during the water washing process, for example.

Excessive de-insertion of lithium near the surface of the lithium-metal composition oxide particles by water washing may result in generation of NiO with Li de-inserted and NiOOH with Li and H substituted, resulting in formation of a layer having a high electric resistance. In addition, by preventing lithium other than surface lithium from being removed by water washing, it is possible to maintain the lithium amount that contributes to charging and discharging large, thereby increasing the discharging capacity. Therefore, as described above, by setting the lithium amount to 0.01% by mass or higher, it is possible to prevent excessive Li removal, increase the initial discharge capacity, and particularly suppress the cathode resistance.

As described above, when LiAlO₂ is formed on the particle surface of the lithium metal composition oxide powder, de-insertion of Al occurs in the particles of the lithium metal composition oxide powder. Therefore, when the lithium metal composition oxide powder is water washed in the manufacturing process, Li near the surface of the particles of the lithium metal composition oxide powder easily escapes from the crystal, is excessively cleaned, and has a lithium amount of less than 0.01% by mass.

On the other hand, the lithium metal composition oxide powder contained in the cathode active material according to the present embodiment suppresses the formation of LiAlO₂ on the particle surface of the lithium metal composition oxide powder as described above. For this reason, because the de-insertion of Al in the particles of the lithium metal composition oxide is suppressed, it is possible to prevent Li near the surface of the particles from escaping from the crystal, and thereby the lithium amount may be set so as to be 0.01% by mass or higher.

The lithium amount in the lithium compound present on the particle surface of the lithium metal composition oxide powder may be slurried by adding a liquid to the lithium metal composition oxide powder, and then quantified by neutralizing and titrating using an acid with the pH of the slurry as an index. Then, the mass ratio of lithium present on the particle surface of the lithium metal composition oxide powder obtained by the quantitation to that of the lithium metal composition oxide powder may be calculated to obtain the above lithium amount.

In the titration, the alkali content in the slurry is quantitated, but the alkali content is considered to be lithium in a lithium compound such as lithium hydroxide, lithium carbonate, and sodium hydrogen carbonate on the particle surface of the powder, except for impurities contained in the lithium metal composition oxide powder. Accordingly, the alkali content determined by neutralization titration may be defined as lithium in a lithium compound present on the particle surface of the lithium metal composition oxide powder, and the mass ratio of the lithium to the lithium metal composition oxide powder may be determined as the lithium amount described above.

That is, the alkali content in the slurry when the lithium metal composition oxide powder is mixed with the liquid and slurried may be considered to be lithium present on the particle surface of the lithium metal composition oxide powder. Then, the ratio of lithium disposed on the particle surface of the lithium metal composition oxide powder, which is obtained by neutralizing and titrating the alkali content in the slurry with an acid, to the lithium metal composition oxide powder may be used as the above lithium amount.

The liquid used to slurry lithium metal composition oxide powder for the titration is not particularly limited, but it is preferable that the powder be pure water in order to prevent impurities from entering the slurry. When purified water is used for the titration, it is preferable that the conductivity of the pure water be low, for example, pure water having the conductivity of less than 10 μS/cm. it is preferable that the conductivity of the pure water be 1 μS/cm or smaller, and it is more preferable that the conductivity of the pure water be 0.5 μS/cm or smaller.

The slurry concentration of the slurry prepared in performing the titration is not particularly limited. However, it is preferable that the ratio of the liquid to the powder of the lithium metal composition oxide 1 be not less than 5 and not more than 100 by mass ratio so that the lithium compound on the particle surface of, for example, the lithium metal composition oxide powder may be sufficiently dissolved in the liquid as a solvent, and the liquid may be easily manipulated by the above titration.

The acid used for performing the titration of the slurry is preferably at least one selected from the group consisting of hydrochloric acid, sulfuric acid, nitric acid, and organic acid, which is normally used for neutralization titration.

The above titration conditions may be used for the neutralization titration of alkaline solutions with a pH index, and the equivalence point may be determined from the inflection point of the pH. For example, the equivalence point for lithium hydroxide is around pH 8, and the equivalence point for lithium carbonate is around pH 4.

In addition, it is preferable that the lithium metal composition oxide powder containing the cathode active material according to the present embodiment, after water is added to the lithium metal composition oxide powder and slurried, the aluminum concentration in the filtrate obtained by solid-liquid separation is suppressed.

Specifically, it is preferable that water of 36 mL is added to the lithium metal composition oxide powder of 45 g, and after stirring for 15 minutes, the aluminum concentration contained in the filtrate obtained by separating the solid and liquid is 1.3 g/L or lower.

This means that when the concentration of aluminum in the filtrate obtained by the above procedure is 1.3 g/L or lower, it is a lithium metal composition oxide powder with a particularly high maintenance ratio of Al as described above. Therefore, when the cathode active material including the lithium metal composition oxide powder is applied to the non-aqueous electrolyte secondary battery, the cathode resistance is particularly suppressed, and the initial discharge capacity may be particularly increased.

More preferably, the concentration of aluminum in the filtrate obtained by the above procedure is 0.7 g/L or smaller. Because it is more preferable that aluminum is not dissolved in the filtrate, the lower limit of aluminum concentration in the filtrate may be set at 0 g/L. That is, the concentration of aluminum in the filtrate may be 0 g/L or more.

Although the water used to form the filtrate is not particularly limited, for example, water similar to that used in the water washing for Al maintenance evaluation described above may be used. Therefore, the description will not be repeated here. In addition, it is preferable to select the temperature of the water so that the temperature of the slurry obtained by adding water to the lithium metal composition oxide powder is, for example, 10° C. or higher and 40° C. or lower.

The means for separating the slurry obtained by mixing and stirring the lithium metal composition oxide powder with water is not particularly limited. However, for example, various filtration means may be used.

Specifically, one or more types selected from a filter press, suction filtration using a Buchner funnel, or the like may be used.

The method of evaluating the concentration of aluminum in the filtrate is not particularly limited, but it is preferable to use, for example, ICP optical emission spectroscopy.

According to the cathode active material according to the above embodiment, the loss of Al in the lithium metal composition oxide powder contained in the cathode active material is suppressed, and the formation of the high resistance portion is suppressed. Therefore, when the cathode active material according to this embodiment is applied to the non-aqueous electrolyte secondary battery, it is possible to suppress the cathode resistance and increase the initial discharge capacity.

In addition, when lithium on the particle surface of the lithium metal composition oxide powder is used as the cathode active material removed by water washing or the like, the surface lithium adhered to the particle surface of the lithium metal composition oxide powder may be reduced, so that the initial discharge capacity may be particularly increased and the cathode resistance may be particularly suppressed.

Incidentally, because the lithium metal composition oxide powder contained in the cathode active material according to the present embodiment suppresses the de-insertion of Al inside the particles, it is possible to prevent the de-insertion of lithium other than surface lithium even when the above water-washing treatment is performed. Therefore, the initial discharge capacity may be particularly increased, and the cathode resistance may be particularly suppressed.

Furthermore, it is possible to suppress the generation of gas even when the active material for the cathode is used as the material for the secondary battery and charged and discharged at a high temperature.

(2) Manufacturing Method of the Cathode Active Material

Next, a method for manufacturing a cathode active material for a non-aqueous electrolyte secondary battery according to this embodiment (hereinafter, also referred to as a “method for manufacturing a cathode active material”) is described. According to the method of manufacturing the cathode active material according to the present embodiment, the above cathode active material may be manufactured. For this reason, the explanation shall be omitted for some of the matters already explained.

The method of manufacturing the cathode active material according to this embodiment may include at least the following mixing steps and a firing process.

General Formula: A mixing step of mixing a nickel composition oxide represented by general formula: Ni1−x−y−tCoxAlyMtO1+β (where 0<x≤0.15, 0<y≤0.07, 0≤t≤0.1, x+y+t≤0.16, −0.10≤β≤0.15, and M is one or more elements selected from Mg, Ca, Ti, V, Cr, Zr, Nb, Mo, Hf, Ta, W) with a lithium compound to prepare a raw material mixture. A firing process in which a baking vessel is filled with a raw material mixture so as to have a thickness of t(mm), and heat-treated in an atmosphere with an oxygen concentration of 60% or more, to produce a lithium metal composition oxide powder. In the firing process, it is preferable that the following conditions (1) to (4) be satisfied by the conditions of the heat treatment until the retention at the maximum reaching temperature is completed.

Condition (1): The firing time Ta (min) in the temperature range of 450° C. or higher and 650° C. or lower satisfies the relationship of Ta≥1.15t with the thickness t(mm) of the raw material mixture filled into the firing vessel.

Condition (2): The maximum reaching temperature is between 730° C. or higher and 780° C. or lower.

Condition (3): The holding time Tb at the maximum reaching temperature is 30 minutes or longer.

Condition (4): The total firing time in the temperature range of 650° C. or higher and the maximum reaching temperature or shorter is 30 minutes or longer.

Each process is described below.

### [Mixing Process]

In the mixing process, a nickel composition oxide and a lithium compound may be mixed to obtain a raw material mixture.

The ratio when the nickel composition oxide is mixed with the lithium compound is not particularly limited, and may be selected depending on the composition of the cathode active material to be manufactured.

The ratio (Li/Me) of the number of lithium atoms (Li) to the number of non-lithium metal atoms (Me) in the raw material mixture hardly varies before and after the firing process. That is, Li/Me in the raw material mixture subjected to the firing process is almost the same as Li/Me in the obtained lithium metal composition oxide powder. Therefore, it is preferable to mix Li/Me in the raw material mixture to be prepared in the mixing process so as to be the same as Li/Me in the desired lithium metal composition oxide powder.

For example, in the mixing step, it is preferable to mix so that the ratio of the number of atoms (Me) of a non-lithium metal to the number (Li) of lithium atoms (Li/Me) in the mixture is 0.95 or greater and 1.03 or smaller. By setting Li/Me to 0.95 or greater, it is possible to suppress the loss of Li or the contamination of Li with the metal elements other than Li in the crystal of the lithium metal composition oxide, thereby increasing the charge/discharge capacity of the lithium metal composition oxide in particular.

In addition, when Li/Me is set to be 1.03 or greater, the residual of unreacted Li may be suppressed, and the ratio of lithium metal composition oxide in the cathode active material may be particularly increased.

A lithium compound selected from, for example, lithium hydroxide, lithium carbonate, etc., or a mixture thereof may be used, although the lithium compound to be subjected to the mixing step is not particularly limited.

When lithium hydroxide is used as the lithium compound, it is preferable to use lithium hydroxide anhydride after anhydrous treatment.

As a mixing means for mixing the lithium compound and the nickel composition oxide in the mixing step, a general mixing machine may be used. For example, a shaker mixer, a LÖDIGE mixer, a Julia mixer, a V blender, or the like may be used.

The nickel composition oxide may be obtained by, for example, preparing the nickel compound hydroxide by a crystallization method and roasting or the like.

The nickel composition oxide may have a composition represented by the general formula: Ni_{1-x-y-t}CoₓAl_{y}MₜO_{1+β} (provided, however, that 0<x≤0.15, 0<y≤0.07, 0<t≤0.1, x+y+t≤0.16, −0.10≤β≤0.15, and M is one or more elements selected from Mg, Ca, Ti, V, Cr, Zr, Nb, Mo, Hf, Ta, W).

Incidentally, when the additional element M is not added, the nickel composition oxide is represented by the general formula: Ni_{1-x-y}CoₓAl_{y}O_{1+β} (where 0<x≤0.15, 0<y≤0.07, x+y≤0.16, and −0.10≤β≤0.15).

The physical properties of the powder of the nickel composition oxide are not particularly limited. However, for example, the average particle diameter may be 5 μm or more and 20 μm or less. This is because the average particle diameter of 5 μm or more increases the handling efficiency, and therefore, the coating efficiency of the slurry when forming the electrode using the obtained active material of the cathode can be improved. In addition, by setting the average particle diameter to 20 μm or less, when the electrode is manufactured using the obtained cathode active material, the smoothness at the electrode surface may be increased.

For example, the bulk density of the nickel composition oxide may be 1 g/cc or greater and 2 g/cc or smaller.

### [Firing Process]

In the firing process, the raw material mixture obtained in the above mixing process is fired to form the lithium metal composition oxide powder, which is used as a cathode active material. When the raw material mixture is fired in the firing process, lithium in the lithium compound diffuses into the nickel composition oxide and a lithium metal composition oxide is formed. However, at this time, it is preferable to select the firing condition so as to suppress the de-insertion of Al.

Specifically, it is preferable that the raw material mixture be filled into the baking container so as to have a thickness of t (mm) and heat treated in an atmosphere having an oxygen concentration of 60% or higher.

In the firing process, it is preferable that the heat treatment conditions until the holding at the maximum reaching temperature is completed, that is, the maximum reaching temperature is reached after the start of the temperature increase, the holding at the maximum reaching temperature is completed, and the cooling starts satisfy the following conditions (1) to (4).

Condition (1): The firing time Ta(min) in the temperature range of 450° C. to 650° C. or lower satisfies the relationship of Ta≥1.15t with the thickness t(mm) of the raw material mixture filled into the firing vessel.

In the temperature range of 450° C. or higher and 650° C. or lower, the loss of Al in the nickel composition oxide is unlikely, but it is assumed that the precursor of the lithium metal composition oxide is formed by gradually diffusing Li, which is lighter than Al, from the lithium compound to the nickel composition oxide. Therefore, it is preferable that the firing time Ta in the temperature range from 450° C. to 650° C. is satisfied in relation to the thickness t of the raw material mixture so that the diffusion of Li proceeds sufficiently by sufficiently heating the raw material mixture while suppressing the de-insertion of Al.

The upper limit of the firing time Ta in the temperature range of 450° C. or higher and 650° C. or lower is not particularly limited, but may be, for example, 3.00 tons or less from the viewpoint of productivity.

Condition (2): The maximum reaching temperature is 730° C. or higher and 780° C. or lower.

Condition (3): The holding time Tb at the maximum reaching temperature is 30 minutes or longer.

The maximum reaching temperature is 730° C. or higher and 780° C. or lower or less and the holding time at the maximum reaching temperature is 30 minutes or longer. Thus, the diffusion of lithium may be sufficiently and uniformly promoted throughout the nickel composition oxide contained in the raw material mixture, while suppressing the de-insertion of Al.

Specifically, by setting the maximum reaching temperature to 730° C. or higher, the diffusion of Li from the lithium compound to the nickel composition oxide may be particularly promoted.

It is considered that the loss of Al from the nickel composition oxide may be prevented by setting the maximum reaching temperature to 780° C. or lower.

Then, by setting the holding time Tb at the maximum reaching temperature to 30 minutes or longer, the entire sample may be uniformly heated to achieve a more uniform composition of the cathode active material. The upper limit of the holding time at the maximum reaching temperature is not particularly limited, but may be, for example, 24 hours or shorter.

Condition (4): The total firing time in the temperature range of 650° C. or higher and the maximum reaching temperature or shorter is 30 minutes or longer.

The temperature range of 650° C. or higher and the maximum reaching temperature or shorter is the temperature range in which the diffusion of Li from lithium compounds to nickel composition oxides is advanced. Therefore, it is considered that it is possible to obtain a cathode active material with a uniform composition while suppressing the de-insertion of Al by setting the firing time in such a temperature range to 30 minutes or longer and securing it sufficiently.

The upper limit of the firing time in the temperature range of 650° C. or higher and the maximum reaching temperature or shorter is not particularly limited. However, it is preferable that the firing time be 20 hours or shorter, for example, and it is more preferable that the firing time be 300 minutes or shorter from the viewpoint of increasing productivity.

During the firing process, it is preferable to be in an oxygen-containing atmosphere continuously, and it is preferable to be in an oxygen-containing atmosphere having an oxygen concentration of 60% or more by volume. This is because the firing process is carried out in an oxygen-containing atmosphere with an oxygen concentration of 60% or more, and the occurrence of oxygen deficiency is suppressed, and loss of Al is suppressed. Because the firing process may be performed in an atmosphere containing only oxygen, the oxygen concentration in the atmosphere containing oxygen may be 100% by volume or less.

The furnace used for firing is not particularly limited, and it may be possible to fire a mixture in an oxygen-containing gas atmosphere. However, from the viewpoint of maintaining the atmosphere in the furnace uniformly, an electric furnace without gas generation is preferable, and either a batch type or a continuous type furnace may be used.

The cathode active material obtained by the sintering process may be coagulated or mildly fired. In this case, it may be crushed.

In this case, crushing is an operation in which mechanical energy is injected into the aggregation composed of multiple secondary particles produced by sintering necking between secondary particles during sintering, etc., and the secondary particles are mutually separated without destroying the secondary particles themselves, and the aggregation is loosened.

The method of manufacturing the cathode active material according to this embodiment may include any process other than the above mixing and firing process.

As described above, the particles of lithium metal composition oxide powder in the cathode active material obtained by the method of manufacturing the cathode active material according to this embodiment may have surface lithium on the surface thereof. Therefore, the method of manufacturing the cathode active material according to the present embodiment may include a water washing step after the firing process described above.

### [Water Washing Process]

Specifically, the method of manufacturing the cathode active material according to the present embodiment may further include a water washing process in which the lithium metal composition oxide powder obtained in the firing process is water washed.

Although the specific conditions and procedures in the water washing step are not particularly limited, the water washing step may include, for example, the following steps.

A slurry forming step in which a slurry is formed by mixing a lithium metal composition oxide powder obtained in a firing step with water so that it contains 500 g or greater and 2000 g or smaller per water of 1 liter. A stirring step in which the slurry obtained in the slurrying step is stirred for 20 minutes or longer and 120 minutes or shorter while maintaining the liquid temperature to be 10° C. or higher and 40° C. or lower.

Separation and drying steps in which the slurry is filtered after the stirring step is completed and the resulting solid is dried.

The steps are described below.

### (Slurrying Step)

In the slurrying step, the slurry may be formed by mixing with water such that the lithium metal composition oxide powder obtained in the sintering step contains 500 g or greater and 2000 g or smaller per water of 1 liter.

If the concentration of the lithium metal composition oxide powder of the slurry formed in the slurry forming step, that is, the slurry concentration is 2000 g/L or smaller, the viscosity of the obtained slurry may be prevented from being excessively high. Thus, stirring of the slurry may be facilitated. Further, because the slurry concentration is 2000 g/L or smaller, surface lithium adhered to the particle surface of the lithium metal composition oxide powder, for example, may be sufficiently dissolved and removed in the slurry.

In addition, by setting the slurry concentration to 500 g/L or greater, productivity may be increased. Further, it is possible to suppress the de-insertion of lithium other than surface lithium from the lithium metal composition oxide powder, for example, lithium near the particle surface of the lithium metal composition oxide powder, from the crystal lattice, thereby sufficiently preventing the crystal structure from collapsing.

If excessive lithium dissolves from the lithium metal composition oxide powder during the water washing process and the slurry becomes high pH, the lithium reacts with carbon dioxide gas in the atmosphere to precipitate lithium carbonate and adhere to the particle surface of the lithium metal composition oxide powder. However, when the slurry concentration is 500 g/L or greater, it is possible to suppress the dissolution of lithium other than surface lithium. Therefore, it is possible to suppress the excessive increase in the pH of the slurry and prevent the re-precipitation and adhesion of the related lithium carbonate.

In particular, considering the productivity from the industrial point of view, it is preferable that the slurry concentration be between 500 g/L or smaller and 2000 g/L or greater in terms of the capacity and workability of the facility.

The water used in preparing the slurry is not particularly limited, but water having an electrical conductivity of less than 10 μS/cm is preferred, and water having an electrical conductivity of 1 μS/cm or is more preferred. That is, water having an electrical conductivity of 10 μS/cm or less is particularly desirable because it prevents deterioration of battery performance due to deposition of impurities on the lithium metal composition oxide powder.

The liquid temperature of the slurry to be prepared in the slurry forming step is not particularly limited. However, it is preferable that the liquid temperature is, for example, 10° C. or higher and 40° C. or lower, and it is more preferable that the liquid temperature is 15° C. or higher and 30° C. or lower.

This is because, by setting the liquid temperature of the slurry to 10° C. or higher, dissolution of surface lithium in water is sufficiently promoted and the lithium amount present on the particle surface of the lithium metal composition oxide powder is sufficiently reduced.

In addition, it is possible to suppress an excessive amount of lithium dissolution from the particle surface of the lithium metal composition oxide by setting the liquid temperature of the slurry to 40° C. or lower. By setting the liquid temperature of the slurry to 40° C. or lower, it is possible to suppress the excessive amount of lithium dissolution and prevent lithium in the slurry from reabsorbing lithium carbonate by reacting with carbon dioxide in the atmosphere.

Therefore, it is possible to suppress the reattachment of lithium hydroxide to the particle surface of the lithium metal composition oxide powder.

### (Stirring Step)

In the stirring step, the slurry obtained in the slurrying step may be stirred for 20 minutes or longer and 120 minutes or shorter while maintaining the liquid temperature at 10° C. or higher and 40° C. or shorter.

As described above, by setting the liquid temperature of the slurry to 10° C. or higher and 40° C. or lower, it is possible to prevent the reattachment of lithium hydroxide to the particle surface of the lithium metal composition oxide, for example, while sufficiently promoting the dissolution of the surface lithium in water. Therefore, the lithium amount in the lithium metal composition oxide powder after water washing may be more reliably 0.1% by mass or smaller.

The time for stirring in the stirring step is not particularly limited, and it may be arbitrarily selected depending on the slurry concentration, the slurry temperature, and the like. The stirring time is preferably 20 minutes or longer and 120 minutes or shorter, for example.

This is because, by stirring for 20 minutes or longer, the surface lithium adhering to the particle surface of the lithium metal-oxide complex powder may be dissolved in a sufficient slurry. However, even if the stirring time is too long, the effect does not change. Therefore, it is preferable that the stirring time be 120 minutes or shorter from the viewpoint of increasing productivity.

### (Separation and Drying Steps)

In the separation and drying step, the slurry after the stirring step is completed and the resulting solids may be dried.

The filtration means is not particularly limited, but various filtration devices such as a filter press or suction filtration using a Buchner funnel may be used.

It is preferable that the amount of adhered water remaining on the particle surface of the solid obtained after filtration of the slurry, that is, the lithium metal composition oxide powder, is small. The reason for this is that if there is a large amount of water adhering to the solid content, lithium dissolved in the liquid may re-precipitate, resulting in an increase in the lithium amount present on the surface of the lithium metal composition oxide powder after drying. It is normally preferable that the deposited water be 10% by mass or lower of lithium metal composition oxide powder.

However, if an attempt is made to excessively reduce the adhered water, the adhered water is preferably has 1% by mass or greater relative to the lithium metal composition oxide powder, because an excessive load is imposed on the filtration device.

After solid-liquid separation, the resulting solid may be dried. Although the drying conditions are not particularly limited, for example, it is preferable that the drying temperature be 80° C. or higher and 700° C. or lower, it is more preferable that the drying temperature be 100° C. or higher and 550° C. or lower, and it is further preferable that the drying temperature be 120° C. or higher and 350° C. or lower.

It is preferable that the drying temperature be 80° C. or higher so that the lithium metal composition oxide powder after water washing is quickly dried, and a gradient of lithium concentration is prevented between the particle surface and the particle interior.

On the other hand, near the surface of the lithium metal composition oxide powder, it is expected to be very close to the stoichiometric ratio or to be slightly less lithium and close to the charged state. Therefore, at temperatures exceeding 700° C., the crystal structure of the powder near the charged state may collapse, resulting in a degradation of its electrical properties. Therefore, as described above, it is preferable that the drying temperature be 700° C. or lower.

In addition, from the viewpoint of increasing the physical properties and the characteristics of the lithium metal composition oxide powder obtained after the water washing process, the drying temperature is more preferably 100° C. or higher and 550° C. or lower, and further preferably 120° C. or higher and 350° C. or lower from the viewpoint of productivity and thermal energy cost.

As a method of drying, the powder after solid-liquid separation is preferably carried out at a predetermined temperature using a dryer which may be controlled under a gas atmosphere or a vacuum atmosphere containing no carbon and sulfur containing compound components.

According to the method of manufacturing the cathode active material according to the above embodiment, it is possible to suppress the loss of Al in the lithium metal composition oxide powder containing the cathode active material to be manufactured, thereby preventing the formation of a high resistance portion. Therefore, when the non-aqueous electrolyte secondary battery is made of the cathode active material obtained by the method of manufacturing the cathode active material according to this embodiment, the cathode resistance is suppressed and the initial discharge capacity is increased.

In addition, when the water washing process is performed and the surface lithium on the particle surface of the lithium metal composition oxide powder is reduced and the removed cathode active material is used, the surface lithium adhered to the particle surface of the lithium metal composition oxide powder may be reduced, so that the initial discharge capacity may be particularly increased and the cathode resistance may be particularly suppressed.

Incidentally, because the lithium metal composition oxide powder inhibits the de-insertion of Al inside the particles, it is possible to prevent the de-insertion of lithium other than surface lithium even when the water washing step is performed. Therefore, the initial discharge capacity may be particularly increased, and the cathode resistance may be particularly suppressed.

Furthermore, it is possible to suppress the generation of gas even when the active material for the cathode is used as the material for the secondary battery and charged and discharged at a high temperature.

### (3) Non-Aqueous Electrolyte Secondary Batteries

Next, a configuration example of a non-aqueous electrolyte secondary battery according to this embodiment will be described.

The non-aqueous electrolyte secondary battery according to this embodiment may have a cathode using the above cathode active material as the cathode material.

First, a structure example of a non-aqueous electrolyte secondary battery according to this embodiment will be described.

The non-aqueous electrolyte secondary battery according to this embodiment may have a structure substantially similar to that of a general non-aqueous electrolyte secondary battery, except that the cathode material uses the above cathode active material.

Specifically, the non-aqueous electrolyte secondary battery according to this embodiment may have a structure with a case and a cathode, an anode, a non-aqueous electrolyte and a separator if necessary contained within the case.

More specifically, for example, the cathode and the anode can be laminated through a separator to form an electrode body, and the obtained electrode body may be impregnated with a non-aqueous electrolyte solution. It is possible to have a structure in which a cathode current collector and a cathode terminal that leads to the outside and an anode current collector and an anode terminal that leads to the outside are respectively connected to each other using a lead for current collection and the like, and the case is sealed thereto.

The structure of the non-aqueous electrolyte secondary battery according to the present embodiment may not be limited to the above examples, and various shapes, such as cylindrical and laminated shapes, may be employed.

An example of the configuration of each member will be described below.

### [Cathode]

First, the cathode is described.

The cathode is a sheet-like member, for example, a cathode material paste containing the previously described cathode active material may be formed by applying and drying the surface of an aluminum foil current collector. The cathode is appropriately processed in accordance with a battery to be used. For example, a cutting process may be performed in which a suitable size is formed depending on the desired battery, or a compression process may be performed by a roll press or the like in order to increase the electrode density.

The above cathode material paste may be formed by adding a solvent to the cathode mixture material and kneading it. The cathode mixture material may be formed by mixing the above active material in powder form, a conductive material, and a binding agent.

The conductive material is added to provide suitable conductivity to an electrode. Although the material of the conductive material is not particularly limited, graphite such as natural graphite, artificial graphite and expanded graphite, or carbon black-based materials such as acetylene black and Ketchen Black™ may be used.

The binder acts as a anchor for the cathode active material. The binder used for such a cathode mixture material is not particularly limited, but one or more kinds selected from, for example, polyvinylidene fluoride (PVDF), polytetrafluoroethylene (PTFE), fluorine rubber, ethylene propylene diene rubber, styrene butadiene, cellulosic resin, polyacrylic acid, or the like may be used.

In addition, activated carbon or the like may be added to the cathode mixture material. The cathode double layer capacity of the cathode can be increased by adding activated carbon or the like to the cathode alloy.

A solvent functions to dissolve the binder and disperse a cathode active material, conductive material, activated carbon, etc. in the binder. The solvent is not particularly limited, but an organic solvent such as, for example, N-methyl-2-pyrrolidone may be used.

In addition, the mixing ratio of each substance in the cathode mixture material paste is not particularly limited, and may be the same as in the case of, for example, the cathode of a general non-aqueous electrolyte secondary battery. For example, when the solid content of the cathode mixture material excluding solvent is 100 parts by mass, the content of the cathode active material may be 60 parts by mass to 95 parts by mass, the content of the conductive material may be 1 part by mass to 20 parts by mass, and the content of the binder may be 1 part by mass to 20 parts by mass.

The method of manufacturing the cathode is not limited to the above method. For example, the cathode can be manufactured by pressing the material and then drying it under a vacuum atmosphere.

### [Anode]

The anode is a sheet-like member formed by applying anode material paste to the surface of a metal foil current collector, such as copper, and drying.

The anode is formed by substantially the same method as that of the above cathode, although the components constituting the anode material paste, the composition thereof, and the material of the current collector differ, and various treatments are performed as necessary as well as the cathode.

The anode paste may be made into a paste by adding a suitable solvent to the anode material which is a mixture of the anode active material and the binding agent.

As the anode active material, for example, a material containing lithium, such as metallic lithium or a lithium alloy, or a absorbing material capable of absorbing and de-inserting lithium ions may be employed.

The adsorbent material is not particularly limited, but one or more kinds selected from, for example, natural graphite, organic compound firing bodies such as artificial graphite, phenolic resins, and carbon material powders such as coke may be used.

When such absorbing material is adopted as the anode active material, a fluorine-containing resin such as PVDF may be used as the binding agent, and as a solvent for dispersing the anode active material in the binding agent, an organic solvent such as N-methyl-2-pyrrolidone may be used.

Incidentally, the method or configuration of manufacturing the anode is not limited to the above examples, and lithium metal or the like machined to a predetermined shape may be used as the anode.

### [Separator]

A separator may be sandwiched between the cathode and anodes as needed. The separator is arranged between the cathode and the anode, and it separates the cathode and the anode, and functions to retain the electrolyte solution.

As the material of the separator, for example, a thin film, such as polyethylene or polypropylene, having a large number of fine pores may be used. However, if the separator has the above function, the separator is not particularly limited.

### [Nonaqueous Electrolyte]

For example, a non-aqueous electrolyte solution may be used as the non-aqueous electrolyte.

The non-aqueous electrolyte solution is a lithium salt as a supporting salt dissolved in an organic solvent. As the non-aqueous electrolyte solution, a lithium salt dissolved in an ionic liquid may be used. The ionic liquid is composed of cations and anions other than lithium-ions and refers to salts that are liquid even at room temperature.

The organic solvent may be used as one kind independently of or a mixture of two or more kinds of a cyclic carbonate such as ethylene carbonate, propylene carbonate, butylene carbonate, or trifluoropropylene carbonate; a chain carbonate such as diethyl carbonate, dimethyl carbonate, ethyl methyl carbonate, or dipropyl carbonate; an ether compound such as tetrahydrofuran, 2-methyl tetrahydrofuran, or dimethoxyethane; a sulfur compound such as ethyl methyl sulfone or butane sultone; or a phosphorus compound such as triethyl phosphate or trioctyl phosphate.

The supporting salt may be LiPF₆, LiBFe, LiClO₄, LiAsF₆, LiN(CF₃SO₂)₂, or a composite salt thereof.

The non-aqueous electrolyte solution may contain a radical scavenger, a surfactant, a flame retardant, or the like to improve the battery property.

As the non-aqueous electrolyte, a solid electrolyte may be used. The solid electrolyte has the property to withstand high voltages. Examples of the solid electrolyte include inorganic solid electrolyte and organic solid electrolyte.

Examples of the inorganic solid electrolyte include an oxide-based solid electrolyte and a sulfide-based solid electrolyte.

The oxide-based solid electrolyte is not particularly limited. For example, a material containing oxygen (O) and having a lithium-ion conductivity and an electron insulating property may be preferably used. Examples of oxide-based solid electrolytes include at least one selected from lithium phosphate (Li₃PO₄), Li₃PO₄NX, LiBO₂NX, LiNbO₃, LiTaO₃, LiaSiO₃, Li₄SiO₄—Li₃PO₄, Li₄SiO₄—Li₃VO₄, Li₂O—B₂O₃—P₂O₅, Li₂O—SiO₂, Li₂O—B₂O₃—ZnO, Li₁₊ₓAlₓTi₂₋ₓ(PO₄)₃ (0≤X≤1), Li_{1+X}Al_{X}Ge_{2-X}(PO₄)₃ (0≤X≤1), LiTi₂(PO₄)₃, Li_{3X}La_{2/3-X}TiO₃ (0≤X≤2/3), Li₅La₃Ta₂O₁₂, Li₇La₃Zr₂O₁₂, Li₆Ba₂Ta₂O₂, Li_{3.6}Si_{0.6}P_{0.4}O₄, and so on.

The sulfide-based solid electrolyte is not particularly limited. For example, a material containing sulfur (S) and having a lithium-ion conductivity and an electron insulating property may be preferably used. Examples of the sulfide-based solid electrolyte include one or more types selected from Li₂S—P₂S₅, Li₂S—SiS₂, LiI—Li₂S—SiS₂, LiI—Li₂S—P₂S₅, LiI—Li₂S—B₂S₃, Li₃PO₄—Li₂S—Si₂S, Li₃PO₄—Li₂S—SiS₂, LiPO₄—Li₂S—SiS, LiI—Li₂S—P₂O₅, LiI—Li₃PO₄—P₂S₅, and so on.

The inorganic solid electrolyte other than the above may be used. For example, Li₃N, LiI, Li₃N—LiI—LiOH, or the like may be used.

The organic solid electrolyte is not particularly limited in the case of a polymer compound exhibiting ionic conductivity. For example, polyethylene oxide, polypropylene oxide, copolymers thereof, and the like may be used. The organic solid electrolyte may also contain a supporting salt (lithium salt).

The non-aqueous electrolyte secondary battery according to this embodiment has a cathode that uses the above cathode active material as the cathode mixture material. Therefore, the cathode resistance is suppressed and the initial discharge capacity is increased. In addition, it may be used as a non-aqueous electrolyte secondary battery with excellent stability by suppressing the reaction other than charge/discharge between the electrolyte solution and the cathode active material.

### [Method for Evaluating Lithium Metal Composition Oxide Powder]

Next, a method for evaluating a lithium metal composition oxide powder according to the present embodiment will be described.

According to the method of evaluating the lithium metal composition oxide powder according to the present embodiment, the amount of Al dissolution of the lithium metal composition oxide powder may be evaluated, and the following steps may be performed.

A slurry forming step of adding water of 36 mL to lithium metal composition oxide powder of 45 g and stirring for 15 minutes to form a slurry. A solid-liquid separation process in which a slurry is separated by solid-liquid separation to form a filtrate.

The evaluation process for the amount of dissolved aluminum to evaluate the aluminum concentration in the obtained filtrate.

First, in the slurry forming step, water of 36 mL may be added to lithium metal composition oxide powder of 45 g, and the obtained is stirred for 15 minutes.

The composition of the lithium metal composition oxide powder used herein is not particularly limited, and a variety of lithium metal composition oxide powders containing Al may be used. For example, a lithium metal composition oxide powder described above with the cathode active material may be used.

The water used is not particularly limited, but it is preferable that the electrical conductivity is low, for example, water having the electrical conductivity of less than 10 μS/cm, and more preferably water having the electrical conductivity of 1 μS/cm or smaller.

In addition, it is preferable to select the temperature of water so that the temperature of the slurry is 10° C. or higher and 40° C. or lower.

In the solid-liquid separation process, the slurry may be separated by solid-liquid separation to form a filtrate.

The means for separating the slurry from the solid liquid is not particularly limited. For example, various filtration means may be used. Specifically, one or more types selected from a filter press, suction filtration using a Buchner funnel, or the like may be used.

In the process of evaluating the amount of aluminum dissolved, it is possible to evaluate the concentration of aluminum in the obtained filtrate.

The method of evaluating the concentration of aluminum in the filtrate is not particularly limited, but it is preferable to use, for example, ICP emission spectroscopy.

The method for evaluating lithium metal composition oxide powders in this embodiment may further include any process. The method of evaluating the lithium metal composition oxide according to the present embodiment may further include the determination step of passing when the concentration of aluminum contained in the filtrate is 1.3 g/L or smaller which is evaluated in, for example, the dissolving aluminum quantity evaluation step.

This means that when the concentration of aluminum in the filtrate obtained by the above procedure is 1.3 g/L or smaller, it is a lithium metal composition oxide powder with a particularly high maintenance ratio of Al as described above. For this reason, when the cathode active material containing such a lithium metal composition oxide powder is applied to a non-aqueous electrolyte secondary battery, it means that the cathode resistance is particularly suppressed and the initial discharge capacity is particularly increased.

In the evaluation process, if the aluminum concentration contained in the filtrate exceeds 1.3 g/L, the filtrate may be rejected.

In particular, it is more preferable that the concentration of aluminum in the filtrate obtained by the above procedure be 0.7 g/L or smaller. In this case, in the determination process, the test may be considered acceptable if the concentration of aluminum in the filtrate is 0.7 g/L or smaller and rejected if the concentration exceeds 0.7 g/L.

Because it is more preferable that aluminum is not dissolved in the filtrate, the lower limit of aluminum concentration in the filtrate may be set to 0 g/L. That is, the concentration of aluminum in the filtrate may be 0 g/L or greater.

According to the method of evaluating the lithium metal composition oxide powder according to the embodiment described above, it is possible to evaluate whether the powder is a lithium metal composition oxide powder having a high maintenance ratio of Al. Therefore, when the cathode active material containing the lithium metal composition oxide powder, which was accepted by the evaluation method of the lithium metal composition oxide powder according to the present embodiment, is used for the non-aqueous electrolyte secondary battery, the initial discharge capacity is increased, and the cathode resistance may be suppressed.

### EXAMPLE

Hereinafter, the invention will be described in more detail with reference to examples. However, the invention is not limited to the following examples.

### Example 1

The cathode active material was prepared and evaluated according to the following procedure.

### (Mixing Process)

As a nickel-containing complex compound, a nickel composition oxide (Ni_{0.90}Co_{0.05}Al_{0.05}O) in which nickel, cobalt, and aluminum are solidly dissolved in a molar ratio of Ni:Co:Al=90:5:5, which is synthesized by a known method, was used. As a lithium compound, a commercially available lithium hydroxide monohydrate (LiOH.H₂O) was anhydrous lithium hydroxide obtained by dehydration with vacuum drying.

The lithium hydroxide anhydride and the nickel composition oxide were weighed so that the ratio of the molar amount of lithium to the total molar amount of nickel, cobalt, and aluminum was 1.015, and then mixed well. The average particle size of the nickel composition oxide was 14 m and the bulk density was 1.1 g/cc.

### (Firing Process)

The resulting mixture was charged into a ceramic firing vessel with an internal dimension of 280 mm (L)×280 mm (W)×90 mm (H) so that the thickness (piled-up thickness) of the mixture was 80 mm. The baking was performed using a continuous firing furnace, Roller Hearth Kiln, by a temperature pattern in which a temperature of 450° C. to 650° C. was raised in an atmosphere containing 70% by volume of oxygen (about 2.0° C./minute) at a constant temperature rise rate of 100 minutes (about 2.0° C./minute), then the temperature was raised to 750° C., the maximum reaching temperature of 5.0° C./minute, and the temperature was maintained at 750° C. for 220 minutes. The time required for the mixture to enter the furnace and exit was 8.0 hours.

The resulting firing body was ground using a pinmill with sufficient strength to maintain the secondary particle shape.

In accordance with the above procedure, a lithium-nickel-cobalt-aluminum composition oxide (Li_{1.015}Ni_{0.90}Co_{0.05}Al_{0.05}O₂), which is a lithium metal composition oxide powder, was obtained as the cathode active material. Incidentally, in Examples 2 to 6, 8 to 12, and 14 to 25 below, a lithium metal composition oxide powder having the same composition is obtained.

### (Evaluation of Cathode Active Material)

### (1) Al Maintenance Ratio

The obtained lithium metal composition oxide powder, which is the cathode active material, was measured using an ICP emission spectrometer (ICPE-9000, manufactured by Shimadzu Corporation), and the molar fraction of Al to Ni and Co, Al/(Ni+Co), was 0.052 from the obtained values.

The obtained lithium metal composition oxide powder was poured into pure water at 20° C. and 1 μS/cm so that water was 0.75 for the lithium metal composition oxide powder 1 by mass ratio. After stirring for 30 minutes, the powder was filtered until the moisture content was 10% or less, and was kept at 0.1 kPa or less at 200° C. for 10 hours (water washing for evaluating the Al maintenance ratio).

The elemental qualities of Ni, Co, and Al of the active cathode after the water washing for evaluating the Al maintenance ratio were measured in the same manner as before the water washing for evaluating the Al maintenance ratio. From the obtained values, the molar fraction of Al to Ni and Co, Al/(Ni+Co) was calculated. At 0.047, the ratio of Al/(Ni+Co) to Al/(Ni+Co) to Al/(Ni+Co) before water washing for evaluating the Al maintenance ratio was 90%.

### (2) Measurement of Surface Lithium Amount

To 10 g of lithium metal composition oxide powder, ultrapure water was added to 100 mL, stirred, and titrated with 1 mol/L hydrochloric acid to a second neutralization point. The alkali content neutralized with hydrochloric acid was used as lithium on the surface of the lithium metal composition oxide powder, and the mass ratio of lithium to the lithium metal composition oxide was calculated from the titration results, and this value was used as the surface lithium amount. The surface lithium amount was 0.15% by mass.

As ultrapure water, a material with an electrical conductivity of 0.5 μS/cm was used.

### (3) Concentration of Aluminum in the Filtrate

For the obtained lithium metal composition oxide which is the cathode active material, 36 mL of water was added to lithium metal composition oxide powder of 45 g, and the slurry was formed by stirring for 15 minutes (slurry forming process). Pure water at 20° C. and 1 μS/cm was used as water, and the temperature of the slurry was maintained at 20° C. while stirring.

Then, the resulting slurry was separated by suction filtration using a Buchner funnel to obtain the filtrate (solid-liquid separation step).

The concentration of aluminum contained in the obtained filtrate was calculated using an ICP emission spectrometer to be 1.21 g/L.

### (4) Initial Discharge Capacity, Cathode Resistance

The performance (initial discharge capacity and cathode resistance) of a secondary battery with a cathode using lithium metal composition oxide powder prepared in the examples above as the cathode active material was evaluated.

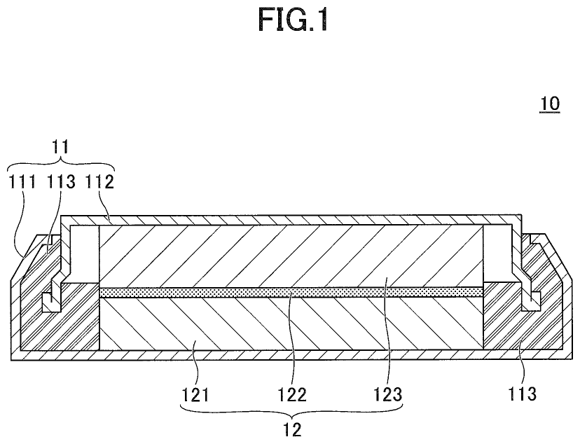

As lithium metal composition oxide powder, the sample before washing the water for Al maintenance evaluation was used. First, the coin battery 10 of the type 2032 illustrated in FIG. 1 was made by the following method, and a charge/discharge evaluation and a cathode resistance evaluation were performed.

The coin battery 10 of the type 2032 is made of a case 11 and an electrode 12 contained within the case 11.

The case 11 includes a cathode can 111 which is hollow and has one opened end and an anode can 112 disposed in the opened end of the cathode can 111. When the anode can 112 is disposed in the opened end of the cathode can 111, a space for accommodating the electrode 12 is formed between the anode can 112 and the cathode can 111.

The electrode 12 is made of a cathode 121, a separator 122, and an anode 123 and is stacked in this order and is accommodated in the case 11 such that the cathode 121 contacts the inner surface of the cathode can 111 and the anode 123 contacts the inner surface of the anode can 112.

The case 11 includes a gasket 113 which secures the cathode can 111 and the cathode can 112 in an electrically insulating condition. The gasket 113 also has a function of sealing a gap between the cathode can 111 and the anode can 112 to provide air-tight and liquid-tight shielding between the inside of the case 11 and the outside.

The coin battery of the type 2032 (CR2032) is made by the following procedure. The cathode 121 was prepared by mixing a cathode active material of 52.5 mg, acetylene black of 15 mg, and PTFE of 7.5 mg, pressing at a pressure of 100 MPa to a diameter of 11 mm and a thickness of 100 μm, and drying in a vacuum dryer at 120° C. for 12 hours.

For the anode 123 of the coin battery 10 of the type 2032, lithium metal having a diameter of 17 mm and a thickness of 1 mm was used. For the non-aqueous electrolyte solution, an equal-mass mixture of ethylene carbonate (EC) and diethyl carbonate (DEC) using LiClO₄ of 1M as the supporting electrolyte (manufactured by Toyama Pharmaceutical Co., Ltd.) was used. In addition, a polyethylene porous membrane having a thickness of 25 μm was used for the separator 122.

The above cathode 121, separator 122, and anode 123 were used to fabricate the coin battery 10 of the type 2032 of the structure illustrated in FIG. 1 in a glove box in an argon (Ar) atmosphere with dew point controlled to −80° C.

The above coin battery 10 of the type 2032 was manufactured and left at room temperature for about 24 hours. After the open circuit voltage OCV (Open Circuit Voltage) was stabilized, it was charged at the cut-off voltage of 4.3 V with a current density of 0.1 mA/cm² relative to the cathode. After a pause of 1 hour, the discharge capacity when the cut-off voltage was discharged at 3.0 V was measured, and the initial discharge capacity was determined. The initial discharge capacity was 195 mAh/g. The multichannel voltage/current generator (manufactured by Advantest corporation, R6741A) was used to measure the initial discharge capacity.

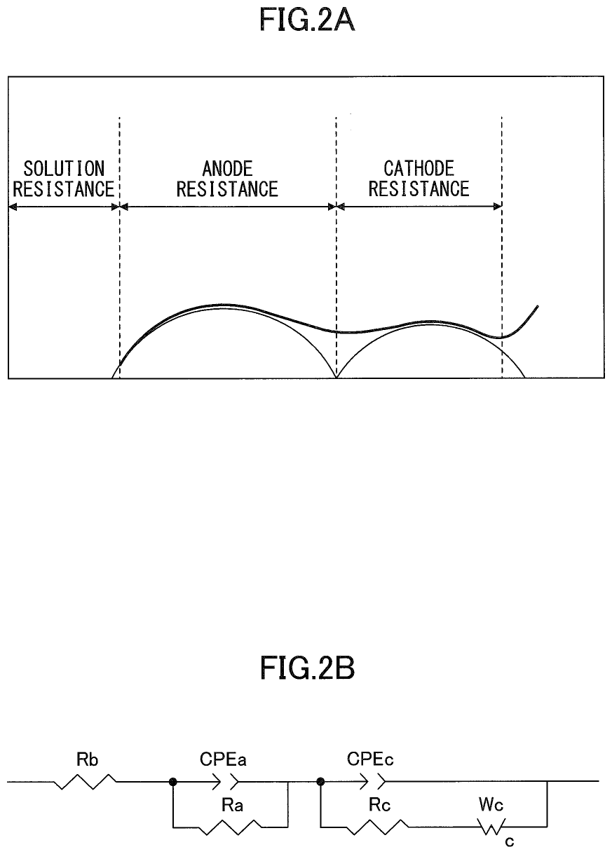

The resistance was measured by an AC impedance method using a coin battery of the type 2032 charged at a charge potential of 4.1 V. The measurements were made using a frequency response analyzer and potentiogalvanostat (manufactured by Solatron) to obtain a Nyquist plot as illustrated in FIG. 2A. Because the plot is represented as the sum of the solution resistance, the cathode resistance and the capacitance, and the characteristic curve representing the cathode resistance and the capacitance, the fitting calculation was performed using an equivalent circuit illustrated in FIG. 2B, and the value of the cathode resistance was calculated. Because the cathode resistance varies greatly depending on the structure and members of the cell, the cathode resistance (Ω) of Example 1 and the cathode resistance of other Examples and Comparative Examples were evaluated as relative values in the evaluation of the cathode resistance of Example 1 and Comparative Examples, respectively. Major test conditions and the Al maintenance ratios, the surface lithium amounts, and the battery evaluation results before and after water washing for evaluating the Al maintenance ratio are given in Table 1.

### Example 2

In the firing process, a lithium metal composition oxide powder, which is the cathode active material, was prepared and evaluated in the same manner as Example 1, except that a part of the firing condition was modified as follows.

In the firing process, a mixture of lithium hydroxide anhydride and a nickel-containing composition oxide was carried into a ceramic firing vessel so that the thickness (piled-up thickness) of the mixture was 50 mm. In addition, the temperature from 450° C. to 650° C. was increased over 60 minutes (about 3.3° C./minute) at a constant rate, and then the temperature was increased at 5.0° C./minute to 750° C., which is the highest attainable temperature, and the temperature was maintained at 750° C. for 220 minutes.

Evaluation results are given in Table 1.

### Example 3

In the firing process, a lithium metal composition oxide powder, which is an active material of the cathode, was prepared and evaluated in the same manner as Example 1, except that a part of the firing condition was modified as follows.

In the firing process, a mixture of lithium hydroxide anhydride and a composite oxide containing nickel was carried into a ceramic firing vessel so that the thickness (piled-up thickness) of the mixture was 20 mm. In addition, the temperature from 450° C. to 650° C. was increased over 30 minutes (about 6.6° C./minute) at a constant rate, and then the temperature was increased at 5.0° C./minute to 750° C., which is the highest attainable temperature, and the temperature was maintained at 750° C. for 220 minutes.

Evaluation results are given in Table 1.

### Example 4

In the firing process, a lithium metal composition oxide powder, which is an active material of the cathode, was prepared and evaluated in the same manner as Example 1, except that a part of the firing condition was modified as follows.

In the firing process, the temperature was raised from 450° C. to 650° C. at a constant rate of increase of 180 minutes (about 1.1° C./minute), and then the temperature was raised to 750° C., the maximum reaching temperature, at 5.0° C./minute, and then kept at 750° C. for 220 minutes.

Evaluation results are given in Table 1.

### Example 5

In the firing process, a lithium metal composition oxide powder, which is an active material of the cathode, was prepared and evaluated in the same manner as Example 1, except that the maximum reaching temperature was changed to 730° C. and kept at 730° C. for 220 minutes.

Evaluation results are given in Table 1.

### Example 6

In the firing process, a lithium metal composition oxide powder, which is an active material of the cathode, was prepared and evaluated in the same manner as Example 1, except that the maximum reaching temperature was changed to 780° C. and kept at 780° C. for 220 minutes.

Evaluation results are given in Table 1.

### Example 7

A lithium metal composition oxide powder (Li_{1.015}Ni_{0.84}Co_{0.11}Al_{0.11}Al_{0.05}O₂), which is the cathode active material, was prepared and evaluated in the same manner as Example 1, except that the nickel composition oxide (Ni_{0.84}Co_{0.11}Al_{0.05}O), which is a solid solution of nickel, cobalt, and aluminum in a molar ratio of Ni:Co:Al=84:11:5, synthesized by a known method, was used as the nickel composition oxide subjected to the mixing process. In Example 13 below, the lithium metal composition oxide powder having the same composition is obtained.

Evaluation results are given in Table 1.

### Example 8

With regard to the lithium metal composition oxide powder (lithium-nickel-cobalt-aluminum composition oxide), which is the fired powder obtained after the firing process in Example 1, the following water washing process was further performed.

In Example 1, the fired powder obtained after the firing process was subjected to a slurry with an electrical conductivity of 0.5 μS/cm and a concentration of 1200 g/L (slurry concentration) by adding pure water with a temperature of 20° C.

The slurry was then stirred (stirring step) for 50 minutes while holding the temperature of the slurry at 20° C.

After the stirring step, the slurry was filtered through a filter press to perform the solid-liquid separation. At this time, the obtained water that adhered to the cathode active material was 5% by mass of lithium metal composition oxide powder. The cathode active material provided with the solid-liquid separation was then allowed to stand for 10 hours (separation and drying step) using a vacuum dryer heated to 150° C.

Then, after the water washing process, a lithium-nickel-cobalt-aluminum composition oxide, which is a lithium metal composition oxide powder, was obtained as the cathode active material, and the cathode active material was evaluated in the same manner as Example 1.

Evaluation results are given in Table 1.

### Example 9

A lithium metal composition oxide powder, which is a fired powder obtained after the firing process in Example 3, was subjected to a water washing process in the same manner as Example 8, and a lithium-nickel-cobalt-aluminum composition oxide powder, which is a lithium metal composition oxide powder, was manufactured as a cathode active material. The resulting cathode active material was evaluated. Evaluation results are given in Table 1.

### Example 10

A lithium metal composition oxide powder, which is a fired powder obtained in Example 4 after the firing process, was subjected to a water washing process in the same manner as Example 8, and a lithium-nickel-cobalt-aluminum composition oxide powder, which is a lithium metal composition oxide powder, was manufactured as the cathode active material. The resulting cathode active material was evaluated. Evaluation results are given in Table 1.

### Example 11

A lithium metal composition oxide powder, which is a fired powder obtained after the firing process in Example 5, was subjected to a water washing process in the same manner as Example 8, and a lithium-nickel-cobalt-aluminum composition oxide powder, which is a lithium metal composition oxide powder, was manufactured as a cathode active material. The resulting cathode active material was evaluated. Evaluation results are given in Table 1.

### Example 12

A lithium metal composition oxide powder, which is a fired powder obtained after the firing process in Example 6, was subjected to a water washing process in the same manner as in Example 8, and a lithium-nickel-cobalt-aluminum composition oxide powder, which is a lithium metal composition oxide powder, was manufactured as a cathode active material. The resulting cathode active material was evaluated. Evaluation results are given in Table 1.

### Example 13

A lithium metal composition oxide powder, which is a fired powder obtained in Example 7 after the firing process, was subjected to a water washing process in the same manner as Example 8, and a lithium-nickel-cobalt-aluminum composition oxide powder, which is a lithium metal composition oxide powder, was manufactured as a cathode active material. The resulting cathode active material was evaluated. Evaluation results are given in Table 1.

### Example 14

In the water washing step, a lithium-nickel-cobalt-aluminum composition oxide, which is a lithium metal composition oxide, was manufactured as the cathode active material in the same manner as Example 8, except that the temperature of the pure water used in the slurrying step was set at 15° C., and the temperature of the slurry was maintained at 15° C. during the stirring step. The resulting cathode active material was evaluated. Evaluation results are given in Table 1.

### Example 15

In the water washing step, a lithium-nickel-cobalt-aluminum composition oxide, which is a lithium metal composition oxide, was manufactured as the cathode active material in the same manner as Example 8, except that the temperature of the pure water used in the slurrying step was set at 35° C., and the temperature of the slurry was maintained at 35° C. during the stirring step. The resulting cathode active material was evaluated. Evaluation results are given in Table 1.

### Example 16

In the water washing step, a lithium-nickel-cobalt-aluminum composition oxide, which is a lithium metal composition oxide, was manufactured as the cathode active material in the same manner as Example 8, except that the temperature of the pure water used in the slurrying step was set at 5° C. and the temperature of the slurry was kept at 5° C. during the stirring step. The resulting cathode active material was evaluated. Evaluation results are given in Table 1.

### Example 17

In the water washing step, the lithium-nickel-cobalt-aluminum composition oxide, which is a lithium metal composition oxide, was manufactured as the cathode active material in the same manner as Example 8, except that the temperature of the pure water used in the slurrying step was set at 45° C. and the temperature of the slurry was maintained at 45° C. during the stirring step. The resulting cathode active material was evaluated. Evaluation results are given in Table 1.

### Example 18

A lithium-nickel-cobalt-aluminum composition oxide, a lithium metal composition oxide, was manufactured as the cathode active material in the slurry forming step of the water washing step in the same manner as Example 8 except that the slurry concentration was 500 g/L. The resulting cathode active material was evaluated. Evaluation results are given in Table 1.

### Example 19

A lithium-nickel-cobalt-aluminum composition oxide, a lithium metal composition oxide, was manufactured as the cathode active material in the slurry forming step of the water washing step in the same manner as Example 8 except that the slurry concentration was 2000 g/L. The resulting cathode active material was evaluated. Evaluation results are given in Table 1.

### Example 20

A lithium-nickel-cobalt-aluminum composition oxide, a lithium metal composition oxide, was manufactured as the cathode active material in the slurry forming step of the water washing step in the same manner as Example 8 except that the slurry concentration was 300 g/L. The resulting cathode active material was evaluated. Evaluation results are given in Table 1.

### Example 21

A lithium-nickel-cobalt-aluminum composition oxide, a lithium metal composition oxide, was manufactured as the cathode active material in the slurry forming step of the water washing step in the same manner as Example 8 except that the slurry concentration was 3000 g/L. The resulting cathode active material was evaluated. Evaluation results are given in Table 1.

### Example 22

Similar to Example 8, a lithium-nickel-cobalt-aluminum composition oxide, which is a lithium metal composition oxide, was manufactured as the cathode active material except that the stirring time of the slurry in the stirring step of the water washing process was 20 minutes. The resulting cathode active material was evaluated.

Evaluation results are given in Table 1.

### Example 23

The lithium-nickel-cobalt-aluminum composition oxide, which is a lithium metal composition oxide, was manufactured as the cathode active material in the same manner as Example 8, except that the stirring time of the slurry in the stirring step of the water washing process was 120 minutes (2 hours). The resulting cathode active material was evaluated. Evaluation results are given in Table 1.

### Example 24

Similar to Example 8, a lithium-nickel-cobalt-aluminum composition oxide, which is a lithium metal composition oxide, was manufactured as the cathode active material except that the stirring time of the slurry in the stirring step of the water washing process was 10 minutes. The resulting cathode active material was evaluated. Evaluation results are given in Table 1.

### Example 25

Similar to Example 8, a lithium-nickel-cobalt-aluminum composition oxide, which is a lithium metal composition oxide, was manufactured as the cathode active material except that the stirring time of the slurry in the stirring step of the water washing process was 180 minutes (3 hours). The resulting cathode active material was evaluated. Evaluation results are given in Table 1.

### Example 26

A lithium-nickel-cobalt-aluminum-magnesium composition oxide (Li_{1.015}Ni_{0.05}Co_{0.05}Al_{0.5}Mg_{0.04}Mg_{0.01}O₂) as a lithium metal composition oxide was manufactured as a cathode active material, except that a nickel composition oxide (Ni_{0.90}Co_{0.05}Al_{0.04}Mg_{0.01}O₂) in which nickel, cobalt, aluminum, and magnesium were solidified in a molar ratio at a ratio of Ni:Co:A:Mg=90:5:4:4:1 synthesized by a known method was used as the nickel composition oxide subjected to the mixing process. The resulting cathode active material was evaluated. Evaluation results are given in Table 1.

### Example 27

A lithium-nickel-aluminum-niobium compound composition oxide (Li_{1.015}Ni_{0.05}Al_{0.04}Nb_{0.01}O₂), which is a lithium metal composition oxide, was manufactured by a known method as a nickel-containing complex compound, except that a nickel composition oxide (Ni_{0.90}Co_{0.05}Al_{0.04}Nb_{0.01}O) in which nickel, cobalt, aluminum, and niobium are solidified at a molar ratio of Ni:Co:Al:Nb=90:5:4:1 was used as the mixture process. The resulting cathode active material was evaluated. Evaluation results are given in Table 1.

### Comparative Example 1

In the firing process, a lithium metal composition oxide powder, which is an active material of the cathode, was prepared and evaluated in the same manner as Example 1, except that the maximum reaching temperature was changed to 800° C. and maintained at 800° C. for 220 minutes.

The evaluation results are given in Table 2.

### Comparative Example 2

In the firing process, a lithium metal composition oxide powder, which is an active material of the cathode, was prepared and evaluated in the same manner as Example 1, except that the atmosphere during firing was made to be an atmosphere having an oxygen concentration of 55% by volume.

The evaluation results are given in Table 2.

### Comparative Example 3

In the firing process, a lithium metal composition oxide powder, which is an active material of the cathode, was prepared and evaluated in the same manner as Example 1, except that a part of the firing condition was modified as follows.

In the firing process, the temperature was raised from 450° C. to 650° C. over 50 minutes (about 4.0° C./minute) at a constant rate, and then the temperature was increased to 750° C., the maximum reaching temperature, at 5.0° C./minute, and then maintained at 750° C. for 220 minutes.

The evaluation results are given in Table 2.

### Comparative Example 4

In the firing process, a lithium metal composition oxide powder, which is an active material of the cathode, was prepared and evaluated in the same manner as Example 1, except that a part of the firing condition was modified as follows.

In the firing process, the temperature was raised from 450° C. to 650° C. over 80 minutes (about 2.5° C./minute) at a constant rate, and then the temperature was increased to 750° C., the maximum reaching temperature, at 5.0° C./minute, and then maintained at 750° C. for 220 minutes.

The evaluation results are given in Table 2.

### Comparative Example 5

In the firing process, a lithium metal composition oxide powder, which is the cathode active material, was prepared and evaluated in the same manner as Example 1, except that the de-inserting time at 750° C., the maximum attained temperature, was 20 minutes.

The evaluation results are given in Table 2.

### Comparative Example 6

A lithium metal composition oxide powder (Li_{1.015}Ni_{0.82}Co_{0.13}Al_{0.05}O₂) as the cathode active material was prepared and evaluated in the same manner as Example 1, except that the nickel composition oxide (Ni_{0.82}Co_{0.13}Al_{0.05}O) synthesized by a known method, in which nickel, cobalt, and aluminum were solidified at a molar ratio of Ni:Co:Al=82:13:5, as the nickel composition oxide used in the mixing process.

The evaluation results are given in Table 2.

TABLE 1

| | | | | | | condition of | | | | | | | |
|---|---|---|---|---|---|---|---|---|---|---|---|---|---|
| | | | | | | water washing process | | | | | | | |
| | | | | | firing | | amount | | | | | | |
| | | | | | time in | | of | | | | | | |
| | | | | | temperature | | lithium | | | | | | |
| | | firing | | | range | | metal | | | | | | |
| | thick- | time | | holding | of | | com- | | | | | | |
| | ness | Ta in | | time | maximum | | position | | evaluation result | | | | |
| | of raw | temper- | maximum | Tb at | reaching | tem- | oxide | | | | aluminum | initial | |
| | ma- | ature | reaching | maximum | temperature | per- | powder | | | surface | concen- | dis- | cath- |
| | terial | range of | temperature | reaching | being | ature | per | stir- | Al | lithium | tration | charge | ode |
| | mix- | 450° C. | in firing | temper- | at lowest | of | water | ring | keeping | content | contained | capacity | resis- |
| | ture t | to 650° C. | process | ature | 650° C. or | slurry | of 1 L | time | rate | (mass | in filtrate | (mAh/ | tance |
| | (mm) | (min.) | (° C.) | (min.) | lower (min.) | (° C.) | (g) | (min.) | (%) | %) | (g/L) | g) | (a.u.) |
| Example 1 | 80 | 100 | 750 | 220 | 240 | — | — | — | 90 | 0.15 | 1.21 | 195 | 100 |
| Example 2 | 50 | 60 | 750 | 220 | 240 | — | — | — | 95 | 0.13 | 0.81 | 199 | 95 |
| Example 3 | 20 | 30 | 750 | 220 | 240 | — | — | — | 96 | 0.13 | 0.74 | 196 | 95 |
| Example 4 | 80 | 180 | 750 | 220 | 240 | — | — | — | 98 | 0.14 | 0.65 | 198 | 95 |
| Example 5 | 80 | 100 | 730 | 220 | 236 | — | — | — | 98 | 0.17 | 0.70 | 199 | 99 |
| Example 6 | 80 | 100 | 780 | 220 | 246 | — | — | — | 91 | 0.13 | 1.14 | 195 | 94 |
| Example 7 | 80 | 100 | 750 | 220 | 240 | — | — | — | 90 | 0.15 | 1.25 | 194 | 99 |
| Example 8 | 80 | 100 | 750 | 220 | 240 | 20 | 1200 | 50 | 99 | 0.03 | 0.59 | 200 | 97 |
| Example 9 | 20 | 30 | 750 | 220 | 240 | 20 | 1200 | 50 | 99 | 0.02 | 0.64 | 201 | 93 |
| Example 10 | 80 | 180 | 750 | 220 | 240 | 20 | 1200 | 50 | 99 | 0.02 | 0.63 | 201 | 92 |
| Example 11 | 80 | 100 | 730 | 220 | 236 | 20 | 1200 | 50 | 99 | 0.03 | 0.52 | 201 | 97 |
| Example 12 | 80 | 100 | 780 | 220 | 246 | 20 | 1200 | 50 | 100 | 0.03 | 0.24 | 200 | 92 |
| Example 13 | 80 | 100 | 750 | 220 | 240 | 20 | 1200 | 50 | 99 | 0.04 | 0.66 | 200 | 97 |
| Example 14 | 80 | 100 | 750 | 220 | 240 | 15 | 1200 | 50 | 99 | 0.05 | 0.60 | 201 | 102 |
| Example 15 | 80 | 100 | 750 | 220 | 240 | 35 | 1200 | 50 | 100 | 0.02 | 0.48 | 198 | 97 |
| Example 16 | 80 | 100 | 750 | 220 | 240 | 5 | 1200 | 50 | 99 | 0.05 | 0.55 | 197 | 100 |
| Example 17 | 80 | 100 | 750 | 220 | 240 | 45 | 1200 | 50 | 100 | 0.02 | 0.43 | 198 | 99 |
| Example 18 | 80 | 100 | 750 | 220 | 240 | 20 | 500 | 50 | 100 | 0.02 | 0.51 | 197 | 98 |
| Example 19 | 80 | 100 | 750 | 220 | 240 | 20 | 2000 | 50 | 99 | 0.09 | 0.63 | 201 | 103 |
| Example 20 | 80 | 100 | 750 | 220 | 240 | 20 | 300 | 50 | 100 | 0.02 | 0.41 | 197 | 99 |
| Example 21 | 80 | 100 | 750 | 220 | 240 | 20 | 3000 | 50 | 99 | 0.11 | 0.68 | 200 | 110 |
| Example 22 | 80 | 100 | 750 | 220 | 240 | 20 | 1200 | 20 | 99 | 0.08 | 0.57 | 199 | 107 |
| Example 23 | 80 | 100 | 750 | 220 | 240 | 20 | 1200 | 120 | 99 | 0.03 | 0.42 | 196 | 106 |
| Example 24 | 80 | 100 | 750 | 220 | 240 | 20 | 1200 | 10 | 99 | 0.11 | 0.55 | 198 | 109 |
| Example 25 | 80 | 100 | 750 | 220 | 240 | 20 | 1200 | 180 | 100 | 0.02 | 0.32 | 196 | 95 |
| Example 26 | 80 | 100 | 750 | 220 | 240 | 20 | 1200 | 50 | 99 | 0.02 | 0.41 | 198 | 99 |
| Example 27 | 80 | 100 | 750 | 220 | 240 | 20 | 1200 | 50 | 99 | 0.02 | 0.43 | 197 | 101 |

TABLE 2

| | | | | | | condition of | | | | | | | |
|---|---|---|---|---|---|---|---|---|---|---|---|---|---|
| | | | | | | water washing process | | | | | | | |
| | | | | | firing | | amount of | | | | | | |
| | | firing | | holding | time in | | lithium | | | | | | |
| | | time | max- | time | range of | | metal | | | | | | |
| | thick- | Ta in | imum | Tb at | maximum | | compo- | | evaluation result | | | | |
| | ness | temper- | reaching | max- | reaching | tem- | sitition | | | | aluminum | | |
| | of raw | ature | temper- | imum | temperature | per- | oxide | | | surface | concen- | | cath- |
| | material | range of | ature | reaching | being | ature | powder per | stir- | Al | lithium | tration | initial | ode |
| | mix- | 450° C. | in firing | temper- | at lowest | of | water of | ring | keeping | content | contained | discharge | resis- |
| | ture t | to 650° C. | process | ature | 650° C. or | slurry | 1 L | time | rate | (mass | in filtrate | capacity | tance |
| | (mm) | (min.) | (° C.) | (min.) | lower (min.) | (° C.) | (g) | (min.) | (%) | %) | (g/L) | (mAh/g) | (a.u.) |
| Comparative | 80 | 100 | 800 | 220 | 250 | — | — | — | 85 | 0.19 | 2.11 | 180 | 105 |
| example 1 | | | | | | | | | | | | | |
| Comparative | 80 | 100 | 750 | 220 | 240 | — | — | — | 89 | 0.17 | 1.42 | 185 | 113 |
| example 2 | | | | | | | | | | | | | |
| Comparative | 80 | 50 | 750 | 220 | 240 | — | — | — | 86 | 0.18 | 1.79 | 184 | 110 |
| example 3 | | | | | | | | | | | | | |
| Comparative | 80 | 80 | 750 | 220 | 240 | — | — | — | 88 | 0.17 | 1.46 | 182 | 108 |
| example 4 | | | | | | | | | | | | | |
| Comparative | 80 | 100 | 750 | 20 | 40 | — | — | — | 89 | 0.18 | 1.38 | 182 | 110 |
| example 5 | | | | | | | | | | | | | |
| Comparative | 80 | 100 | 750 | 220 | 240 | — | — | — | 89 | 0.16 | 1.53 | 180 | 111 |
| example 6 | | | | | | | | | | | | | |

According to the evaluation results of the coin battery using the cathode active material obtained in Examples 1 to 7, it was confirmed that the cathode resistance was low and the initial discharge capacity was high compared to Comparative Examples 1 to 6.

In Examples 8 to 13, according to the evaluation results of the coin battery using the cathode active material obtained by subjecting the lithium metal composition oxide obtained after the firing process of Examples 1 to 7 to the water washing process, it was confirmed that the cathode resistance was further reduced and the initial discharge capacity was higher than that of Examples 1 to 7 before the water washing.

Incidentally, in Examples 14 to 25, by changing the conditions of the water washing process, it was confirmed that the amount of surface lithium changed compared to that of Example 8. In these examples, although it was observed that the cathode resistance was slightly higher than that in Example 8, both were sufficiently suppressed, and it was confirmed that the cathode resistance was low and the initial discharge capacity was high.

Accordingly, by performing the water washing step further and using the surface lithium as the cathode active material that is appropriately removed, it was confirmed that the cathode resistance of the non-aqueous electrolyte secondary battery using the cathode active material may be further reduced and the initial discharge capacity may be further improved.

Furthermore, in Examples 26 and 27, the results of the lithium metal composition oxide obtained in the same manner as Example 8, except that the nickel composition oxide containing magnesium or niobium was used, were similar to those of Example 8, and it was confirmed that the cathode resistance was low and the initial discharge capacity was high even when the other elements were added.

From the above results, it may be confirmed that when using the cathode active material of Examples 1 to 27 including the lithium metal composition oxide powder having suppressed the de-insertion of Al and suppressed the formation of the high resistance, the cathode resistance is suppressed and the initial discharge capacity is increased when the non-aqueous electrolyte secondary battery is used.

In addition, it was confirmed that the non-aqueous electrolyte secondary battery using the cathode active material may further suppress the cathode resistance and increase the initial discharge capacity by performing a water washing treatment under appropriate conditions on the cathode active material including the lithium metal composition oxide powder having inhibited the de-insertion of Al.

As described above, the method of manufacturing the cathode active material for the non-aqueous electrolyte secondary battery, the cathode active material for the non-aqueous electrolyte secondary battery, and the method of evaluating the lithium metal composition oxide powder have been described in the embodiments and the embodiments, but the present invention is not limited to the above embodiments and the examples. Various modifications and variations are possible within the scope of the invention as defined in the claims.

This application claims priority to Patent Application No. 2017-209846 filed with the Japan Patent Office on Oct. 30, 2017, and Patent Application No. 2018-046465 filed with the Japan Patent Office on Mar. 14, 2018. The entire contents of Patent Application No. 2017-209846 and Patent Application No. 2018-046465 are incorporated herein by reference.

1. A cathode active material for a non-aqueous electrolyte secondary battery containing a lithium metal composition oxide powder,
wherein the lithium metal composition oxide powder is represented by a general formula:
Li_{z}Ni_{1-x-y-t}CoₓAl_{y}MₜO_{2+α} (where 0<x≤0.15, 0<y≤0.07, 0≤t≤0.1, x+y+t≤0.16, 0.95≤z≤1.03, 0≤α≤0.15), and M is one or more elements selected from Mg, Ca, Ti, V, Cr, Zr, Nb, Mo, Hf, Ta, W), and
wherein Al/(Ni+Co), which is a mass ratio of Al relative to Ni+Co in the lithium metal composition oxide powder after the lithium metal composition oxide powder of 1 kg is water washed of 750 mL, is 90% or higher of that of the lithium metal composition oxide powder before water washing.

2. The cathode active material for the non-aqueous electrolyte secondary battery containing a lithium metal composition oxide powder according to claim 1,
wherein Al/(Ni+Co), which is the mass ratio of Al relative to Ni+Co in the lithium metal composition oxide powder after the lithium metal composition oxide powder of 1 kg is water washed of 750 mL, is 98% or higher of that of the lithium metal composition oxide powder before water washing, and
wherein when the lithium metal composition oxide powder is washed with water of 750 mL, Al/(Ni+Co) is the mass ratio of Al of the lithium metal composition oxide powder after water washing to the amount of Ni and Co, and is greater than 98% of Al/(Ni+Co) of the lithium metal composition oxide powder before water washing,
wherein, in a case where an alkali content in a slurry, which is obtained by mixing the lithium metal composition oxide powder and a liquid, is regarded as lithium existing on a surface of the particle of the lithium metal composition oxide powder,
a ratio of the lithium on the surface of the particle of the lithium metal composition oxide powder, which is obtained by neutralizing and titrating the alkali content in the slurry with an acid, relative to the lithium metal composition oxide powder is 0.1% by mass or smaller.

3. The cathode active material for the non-aqueous electrolyte secondary battery containing a lithium metal composition oxide powder according to claim 1,
wherein an aluminum concentration contained in filtrate obtained by adding water of 36 mL to the lithium metal composition oxide powder of 45 g, stirring for 15 minutes, and then separating into solid and liquid, is 1.3 g/L or smaller.

4. A method of manufacturing a cathode active material for a non-aqueous electrolyte secondary battery, the method comprising:
a mixing step of mixing a nickel composition oxide represented by a general formula: Ni1−x−y−tCoxAlyMtO1+b (where 0<x≤0.15, 0<y≤0.07, 0≤t≤0.1, x+y+t≤0.16, −0.10≤b≤0.15), and M is one or more elements selected from Mg, Ca, Ti, V, Cr, Zr, Nb, Mo, Hf, Ta, W) with a lithium compound to prepare a raw material mixture; and
a firing step of filling a firing vessel with the raw material mixture so as to have a thickness of t(mm) and performing heat treatment under an atmosphere having an oxygen concentration of 60% by volume or higher and produce a lithium metal composition oxide powder, and
wherein conditions of the heat treatment until an end of a retention at a maximum reaching temperature in the firing step satisfy the following conditions (1) to (4):
condition (1): a firing time Ta (min) in a temperature range of 450° C. or higher and 650° C. or lower satisfies a relationship of Ta≥1.15t with the thickness t(mm) of the raw material mixture filled in the firing vessel;
condition (2): the maximum reaching temperature is between 730° C. or higher and 780° C. or lower;
condition (3): a holding time Tb at the maximum reaching temperature is 30 minutes or longer; and
condition (4): a total firing time in the temperature range of 650° C. or higher and the maximum reaching temperature or lower is 30 minutes or longer.

5. The method of manufacturing the cathode active material for a non-aqueous electrolyte secondary battery according to claim 4, the method further comprising:
a water washing step of water washing the lithium metal composition oxide powder obtained in the firing step.

6. The method of manufacturing the cathode active material for the non-aqueous electrolyte secondary battery according to claim 5,
wherein the water washing step includes
a slurrying step to obtain slurry by mixing the lithium metal composition oxide powder with water so that a ratio of the lithium metal composition oxide powder of 500 g or more and 2000 g or less and the water of 1 L obtained in the firing step,
a stirring step of stirring the slurry obtained in the slurrying step for 20 minutes or longer and 120 minutes or shorter while maintaining a temperature of the slurry at 10° C. or higher and 40° C. or lower, and
a separating and drying step of filtering the slurry after completion of the stirring step, and drying a resulting solid.

7. A method of evaluating a lithium metal composition oxide powder comprising:
a step of forming slurry by adding water of 36 mL to the lithium metal composition oxide powder of 45 g and stirring for 15 minutes; and
a solid-liquid separation step of forming filtrate by applying a solid-liquid separation to the slurry; and
a step of evaluating an amount of dissolved aluminum to evaluate an aluminum concentration contained in the filtrate.

8. The method of evaluating the lithium metal composition oxide powder according to claim 7, the method further comprising:
a determining step of passing the lithium metal composition oxide powder when the aluminum concentration contained in the filtrate is 1.3 g/L or lower, the aluminum concentration being evaluated in the step of evaluating the amount of dissolved aluminum.
